(19) United States
(12) Patent Application Publication
(10) Pub. No.: US 2025/0212207 A1
(43) Pub. Date: Jun. 26, 2025

(54) METHOD AND NETWORK DEVICE FOR DETERMINING SCHEDULING INFORMATION TYPE

(71) Applicant: REALME CHONGQING MOBILE TELECOMMUNICATIONS CORP., LTD., Chongqing (CN)

(72) Inventor: Yuchun LUO, Chongqing (CN)

(73) Assignee: REALME CHONGQING MOBILE TELECOMMUNICATIONS CORP., LTD., Chongqing (CN)

(21) Appl. No.: 19/078,804

(22) Filed: Mar. 13, 2025

Related U.S. Application Data
(63) Continuation of application No. PCT/CN2023/098593, filed on Jun. 6, 2023.

(30) Foreign Application Priority Data
Sep. 15, 2022 (CN) 202211124541.6

(51) Int. Cl. H04W 72/1263; H04B 17/318

(52) U.S. Cl. CPC H04W 72/1263; H04B 17/328

(57) ABSTRACT

A method and a network device for determining the type of scheduling information. The method is performed by a network device and includes: obtaining at least one of indicators reflecting a signal situation of a terminal device within a sliding time window, and a movement state of the terminal device; and determining the scheduling information type according to the at least one of the indicators reflecting the signal situation within the sliding time window and the movement state of the terminal device; wherein the scheduling information type is either cross-slot scheduling or within-slot scheduling.

### CROSS-REFERENCE TO RELATED APPLICATIONS

The present application is a continuation-application of International (PCT) Patent Application No. PCT/CN2023/098593, filed on Jun. 6, 2023, which claims priority of Chinese Patent Application No. 202211124541.6, filed on Sep. 15, 2022, the entire contents of which are hereby incorporated by reference in their entirety.

### TECHNICAL FIELD

The present disclosure relates to the technical field of communications, and in particular to a method and a network device for determining the type of scheduling information.

### BACKGROUND

In an existing technical scheme, when a terminal device is performing ordinary Internet services, it is likely to use time slot scheduling. When the terminal device is in a state of high-speed movement or the signal state changes drastically, there may be a significant difference between the signal state and the scheduling information previously sent by the base station.

### SUMMARY OF THE DISCLOSURE

The present disclosure provides a method and a network device for determining the type of scheduling information.

In a first aspect, the present disclosure provides a method for determining a scheduling information type, performed by a network device and including: obtaining at least one of: indicators reflecting a signal situation of a terminal device within a sliding time window, and a movement state of the terminal device; and determining the scheduling information type according to the at least one of the indicators reflecting the signal situation within the sliding time window and the movement state of the terminal device; wherein the scheduling information type is either cross-slot scheduling or within-slot scheduling.

In a second aspect, the present disclosure provides a method for determining a scheduling information type, performed by a terminal device and including: reporting to a network device at least one of: indicators reflecting a signal situation of a terminal device within a sliding time window, and a movement state of the terminal device; wherein the at least one of the indicators reflecting the signal situation within the sliding time window and the movement state of the terminal device is configured to determine the scheduling information type, and the scheduling information type is either cross-slot scheduling or within-slot scheduling.

In a third aspect, the present disclosure provides a network device, including: a memory, storing executable program code; and a processor and a transceiver, that are coupled to the memory; wherein the network device is configured to perform the method as in the first aspect.

### BRIEF DESCRIPTION OF THE DRAWINGS

In order to more clearly illustrate the technical solution in the embodiments of the present disclosure, the following is a brief description of the drawings needed to be used in the description of the embodiments. Obviously, the drawings in the following description are only some embodiments of the present disclosure, and other drawings may be obtained based on these drawings.

FIG. 1 is a system architecture diagram of a communication system according to some embodiments of the present disclosure.

FIG. 2 is a flowchart of a method for determining scheduling information type according to some embodiments of the present disclosure.

FIG. 3 is a flowchart of a method for determining scheduling information type according to other embodiments of the present disclosure.

FIG. 4 is a schematic diagram of an apparatus for determining scheduling information type according to some embodiments of the present disclosure.

FIG. 5 is a schematic diagram of an apparatus for determining scheduling information type according to other embodiments of the present disclosure.

FIG. 6 is a schematic diagram of a network device according to some embodiments of the present disclosure.

FIG. 7 is a schematic diagram of a terminal device according to some embodiments of the present disclosure.

FIG. 8 is a schematic diagram of a network device according to other embodiments of the present disclosure.

FIG. 9 is a schematic diagram of a terminal device according to other embodiments of the present disclosure.

### DETAILED DESCRIPTION

The embodiments of the present disclosure provide a method, an apparatus, a network device, a terminal device, and a storage medium for determining the type of scheduling information, so as to determine the feasibility of scheduling across time slots by evaluating at least one of the signal situations and movement state of the terminal device, such that the scheduling result is more in line with the signal situations of the terminal device when it is in service, and the overall throughput rate is improved.

In order to enable those skilled in the art to better understand the present disclosure, the technical solution of the embodiments of the present disclosure will be described below in conjunction with the accompanying drawings of the embodiments of the present disclosure. Obviously, the embodiments described are only a portion of the embodiments of the present disclosure, not all of the embodiments. All embodiments based on the embodiments of the present disclosure shall fall within the scope of the present disclosure.

The 5G data transmission process is as follows: a base station sends a scheduling information (which may be sent via downlink control information (DCI)) to a terminal device, and the terminal device sends or receives data at corresponding time and frequency domain resources according to the content of the scheduling information. The time for sending or receiving data services may be in the same time slot as the scheduling information, or in a different time slot.

In 5G downlink transmission, the time between receiving the scheduling information and receiving the downlink data is related to the parameter KO carried in the DCI, as well as the carrier interval of the Physical Downlink Shared Channel (PDSCH) and the Physical Downlink Control Channel (PDCCH). The time interval between receiving the scheduling information and receiving the downlink data may be in the same time slot or multiple time slots later.

In 5G uplink transmission, the time between receiving the scheduling information and transmitting the uplink data is related to the parameter K2 carried in the DCI, as well as the carrier interval of the Physical Uplink Control Channel (PUSCH) and PDCCH. The time interval between receiving the scheduling information and transmitting the uplink data may be in the same time slot or multiple time slots later.

It should be noted that because the scheduling process for uplink data transmission and downlink data transmission is similar across time slots, this specification uses the selection of downlink data transmission as an example to illustrate.

In the related art, there is no stipulation on whether data transmission should be scheduled across time slots or within time slots, and the scheduling method is determined by the network device manufacturer. For services with high real-time requirements (for example, autonomous driving), scheduling within time slots is applied; for other services (for example, ordinary Internet access services), scheduling across time slots is applied.

A problem is raised along therewith. When the terminal device is performing ordinary Internet access, according to the technical schemes in the related art, it is likely to adopt cross-slot scheduling. In this case, if the terminal device is in a state of high-speed movement or the signal state changes drastically, there may be a significant difference between the signal state and the scheduling information previously sent by the base station. For example, when the base station sends scheduling information to the terminal device, it evaluates that the terminal device is in a situation with good signal quality, and the coding and modulation method adopted for scheduling at this time matches the situation with good signal (using a high-order modulation method). However, when the terminal device initiates data service after a number of time slots, the signal deteriorates. In this case, the coding and modulation method in the scheduling information does not match the actual signal, and a high bit error rate may occur.

The technical schemes proposed in the present disclosure may be applied to various communication systems, for example, the Global System for Mobile communication (GSM) system, the Code Division Multiple Access (CDMA) system, the Wideband Code Division Multiple Access (WCDMA) system, the General Packet Radio Service (GPRS), the Long Term Evolution (LTE) system, Advanced long term evolution (LTE-A) systems, New Radio (NR) systems, Evolved systems of NR systems, LTE-based access to unlicensed spectrum (LTE-U) systems, NR-based access to unlicensed spectrum (NR-U) systems, Non-Terrestrial Networks (NTN) systems, Universal Mobile Telecommunication System (UMTS), Wireless Local Area Networks (WLAN), Wireless Fidelity (WiFi), 5th-Generation (5G), or other communication systems.

Generally speaking, conventional communication systems support a limited number of connections and are easy to implement. However, with the development of communication technology, mobile communication systems will not only support traditional communication, but also support, for example, device-to-device (D2D) communication, machine-to-machine (M2M) communication, machine type communication (MTC), vehicle-to-vehicle (V2V) communication, or vehicle-to-everything (V2X) communication. The embodiments of the present disclosure may further be applied to the above-mentioned communication systems.

In some embodiments, the communication system of the present disclosure may be applied to carrier aggregation (CA) scenarios, dual connectivity (DC) scenarios, and standalone (SA) networking scenarios.

In some embodiments, the communication system of the present disclosure may be applied to unlicensed spectrum, where the unlicensed spectrum may be considered as shared spectrum; or the communication system of the present disclosure may be applied to licensed spectrum, where the licensed spectrum may be considered as non-shared spectrum.

The present disclosure describes various embodiments in combination with network devices and terminal devices, where the terminal device may be referred to as a user equipment (UE), an access terminal, a user unit, a user station, a mobile station, a mobile set, a remote station, a remote terminal, a mobile device, a user terminal, a terminal, a wireless communication device, a user agent, or a user device.

The terminal device may be a station (STAION, ST) in a WLAN, a cellular phone, a cordless phone, a Session Initiation Protocol (SIP) phone, a Wireless Local Loop (WLL) station, a Personal Digital Assistant (PDA) device, a handheld device with wireless communication capabilities, a computing device or other processing device connected to a wireless modem, an in-vehicle device, a wearable device, terminal device in next-generation communication systems such as NR networks, or terminal device in future-evolved Public Land Mobile Network (PLMN) networks.

In the embodiments of the present disclosure, the terminal device may be deployed on land, including indoors or outdoors, handheld, wearable, or vehicle-mounted; it may further be deployed on water (e.g., on a ship, etc.); it may further be deployed in the air (e.g., on an aircraft, balloon, satellite, etc.).

In the embodiments of the present disclosure, the terminal device may be a mobile phone, a tablet, a computer with wireless transceiver function, a virtual reality (VR) terminal device, an augmented reality (AR) terminal device, a wireless terminal device in industrial control, a wireless terminal device in self-driving, a wireless terminal device in remote medical, a wireless terminal device in smart grid, wireless terminal device in transportation safety, wireless terminal device in smart cities or wireless terminal device in smart homes, wearable devices, etc.

In the embodiments of the present disclosure, the network device may be a device for communicating with a mobile device. The network device may be an access point (AP) in WLAN, a base station (Base Transceiver Station, BTS) in GSM or CDMA, or a base station (NodeB, NB) in WCDMA, or an evolved base station (Evolutional Node B, eNB or eNodeB) in LTE, or a relay station or an access point, or a vehicle-mounted device, a wearable device, and a network device (gNB) in an NR network or a network device in a future evolved PLMN network or a network device in an NTN network, etc.

As an example and not as a limitation, in the embodiments of the present disclosure, the network device may have mobile characteristics, e.g., the network device may be a mobile device. In some embodiments, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, etc. In some embodiments, the network device may be a base station located on land, in water, etc.

In the embodiments of the present disclosure, the network device may provide services to a cell, and the terminal device may communicate with the network device using transmission resources (e.g., frequency domain resources, or spectrum resources) of the cell. The cell may be a cell corresponding to the network device (e.g., a base station), and the cell may belong to a macro base station or a base station corresponding to a small cell. The small cell may include a metro cell, a micro cell, Pico cell, Femto cell, etc. These small cells have the characteristics of small coverage and low transmission power, and are suitable for providing high-speed data transmission services.

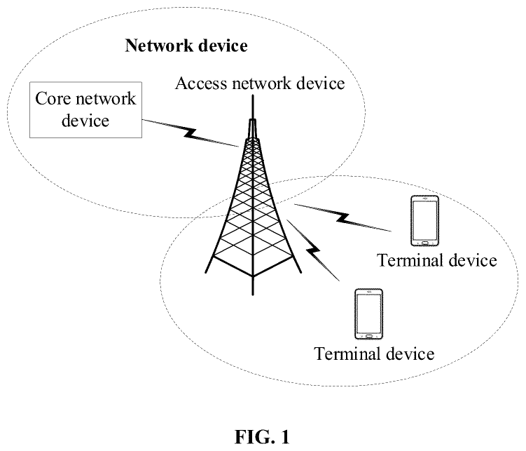

As shown in FIG. 1, FIG. 1 is a system architecture diagram of a communication system according to some embodiments of the present disclosure. The communication system may include a network device, which may be a device that communicates with a terminal device (or referred to as a communication terminal, a terminal). The network device can provide communication coverage for a specific geographical area and can communicate with terminal devices located within the coverage area. FIG. 1 shows an example of a network device and two terminal devices. In some embodiments, the communication system may include multiple network devices and each network device may have a coverage area that includes a different number of terminal devices, which is not limited herein. In some embodiments, the communication system may further include other network entities such as a network controller and a mobility management entity, which is not limited herein.

The network devices may further include an access network device and a core network device. That is, the wireless communication system further includes multiple core networks for communicating with the access network device. The access network device may be evolutional node B (eNB or e-NodeB for short) macro base stations, micro base stations (also known as “small base stations”), pico base stations, and access points (APs), transmission points (TP), or new generation Node B (gNodeB), etc. in a long-term evolution (LTE) system, a next radio (NR) system, or an authorized auxiliary access long-term evolution (LAA-LTE) system.

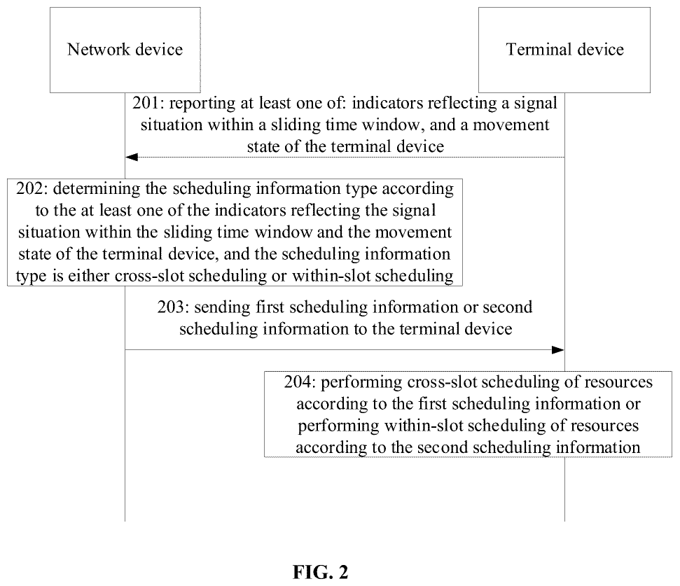

The technical solutions of the present disclosure are further illustrated by way of examples. As shown in FIG. 2, FIG. 2 is a flowchart of a method for determining scheduling information type according to some embodiments of the present disclosure. The method includes operations illustrated herein.

Operation 201: a terminal device reports to a network device at least one of: indicators reflecting a signal situation within a sliding time window, and a movement state of the terminal device; where the at least one of the indicators reflecting the signal situation within the sliding time window and the movement state of the terminal device is configured to determine a scheduling information type, and the scheduling information type is either cross-slot scheduling or within-slot scheduling.

The network device obtains at least one of the indicators reflecting the signal situation within the sliding time window and the movement state of the terminal device from the terminal device.

In some embodiments, the indicator reflecting the signal situation includes at least one of Reference Signal Receiving Power (RSRP), Received Signal Strength Indicator (RSSI), Reference Signal Receiving Quality (RSRQ), and Block Error Rate (BLER). It is understood that RSRP, RSSI, RSRQ, and BLER may be measurement results reported by the terminal device to the network device.

It is understood that the network device may obtain the indicators reflecting the signal situation of the terminal device in multiple sliding time windows. Taking the network device being a base station as an example, the base station maintains signal changes of the indicators reflecting the signal situation of each terminal device within different sliding time windows based on a measurement result reported by the terminal device. The indicator reflecting the signal situation may include RSRP, RSSI, RSRQ, and BLER.

In some embodiments, the movement state of the terminal device may include a first movement state or a second movement state, where a movement speed of the first movement state is greater than a movement speed of the second movement state.

In some embodiments, the movement state of the terminal device may further include a third movement state, where the movement speed of the first movement state is greater than a movement speed of the third movement state, and the movement speed of the third movement state is greater than the movement speed of the second movement state.

In some embodiments, the movement state of the terminal device may be determined based on a movement speed of the terminal device, the number of cells to which the terminal device switches connections within a preset period of time, the indicator reflecting the signal situation, or other implementations, without being limited here.

For example, when the movement speed of the terminal device is greater than or equal to 40 m/s, the movement state of the terminal device may be considered to be the first movement state, which may also be referred to as a high-speed movement state; for example, when the movement speed of the terminal device is greater than or equal to 10 m/s and less than 40 m/s, the movement state of the terminal device may be considered to be the third movement state, which may also be referred to as a low-speed movement state; for example, when the movement speed of the terminal device is less than 10 m/s, the movement state of the terminal device may be considered to be the second movement state, which may also be referred to as a normal movement state.

For example, when the number of cells to which the terminal device switches connections is greater than 3 within 5 minutes, the movement state of the terminal device may be considered to be the first movement state; when the number of cells to which the terminal device switches connections is greater than 1 and less than or equal to 3 within 5 minutes, the movement state of the terminal device may be considered to be the third movement state; and when the number of cells to which the terminal device switches connections is less than or equal to 1 within 5 minutes, the movement state of the terminal device may be considered to be the second movement state.

Operation 202: the network device determines the scheduling information type according to the at least one of the indicators reflecting the signal situation within the sliding time window and the movement state of the terminal device, and the scheduling information type is either cross-slot scheduling or within-slot scheduling.

In some embodiments, the network device determines the scheduling information type according to the indicator reflecting the signal situation within the sliding time window, which may include:
in a case where a change in a maximum value and a minimum value of each of at least one indicator included in the indicators reflecting the signal situation within the sliding time window is greater than a corresponding first preset value, the scheduling information type is determined to be within-slot scheduling; and/or
in a case where a change in a maximum value and a minimum value of each indicator included in the indicators reflecting the signal situation within the sliding time window is less than or equal to a corresponding second preset value, the scheduling information type is determined to be cross-slot scheduling; where the corresponding first preset value is greater than or equal to the corresponding second preset value.

In some embodiments, the corresponding first preset value is greater than or equal to the corresponding second preset value, and in a case where the change in the maximum value and the minimum value of each indicator included in the indicators reflecting the signal situation within the sliding time window is greater than the corresponding second preset value and less than or equal to the corresponding first preset value, the scheduling information type is determined to be an existing scheduling information type; when the existing scheduling information type is within-slot scheduling, the scheduling information type is determined to be within-slot scheduling, and when the existing scheduling information type is cross-slot scheduling, the scheduling information type is determined to be cross-slot scheduling. That is, the scheduling information type is not changed. The network device may send instruction information to the terminal device, instructing not to change the scheduling information type, and the terminal device schedules resources according to the existing scheduling information; alternatively, the network device may not send instruction information to the terminal device, and the terminal device schedules resources according to the existing scheduling information.

In some embodiments, in a case where the change in the maximum value and the minimum value of each indicator included in the indicators reflecting the signal situation within the sliding time window is less than or equal to the corresponding second preset value, the scheduling information type is determined to be cross-slot scheduling, which may include: in a case where the change in the maximum value and the minimum value of each indicator included in the indicators reflecting the signal situation within the sliding time window is less than or equal to the corresponding second preset value, and the scheduling information type determined in a previous phase is within-slot scheduling, the scheduling information type is determined to be cross-slot scheduling.

For example, taking the indicator reflecting the signal situation within the sliding time window being RSRP as an example, the base station determines whether a value of a maximum RSRP of the terminal device minus a minimum RSRP of the terminal device within a sliding time window T1 is greater than a threshold RSRP_th_up, and the sliding time window T is reset when the value does not exceed the RSRP_th_up within the sliding time window T1.

When RSRP_max−RSRP_min>RSRP_th_up, it is determined that the scheduling information type is within-slot scheduling not cross-slot scheduling.

When the base station determines that the value of the maximum RSRP of the terminal device minus the minimum RSRP of the terminal device within the sliding time window T1 is less than or equal to a threshold RSRP_th_down, and the scheduling information type in the previous phase is within-slot scheduling, the scheduling information type is updated to cross-slot scheduling.

That is, when RSRP_max−RSRP_min<=RSRP_th_down, the scheduling information type is determined to be cross-slot scheduling.

For example, taking the indicator reflecting the signal situation within the sliding time window being RSSI as an example, when the base station determines that a value of a maximum RSSI of the terminal device minus a minimum RSSI of the terminal device within a sliding time window T1 is greater than a RSSI threshold RSSI_th_up, the scheduling information type is determined to be within-slot scheduling, not cross-slot scheduling; when the value of the maximum RSSI of the terminal device minus the minimum RSSI of the terminal device within the sliding time window T1 is less than or equal to RSSI_th_down, the scheduling information type is determined to be cross-slot scheduling.

For example, taking the indicator reflecting the signal situation within the sliding time window being RSRQ as an example, when the base station determines that a value of a maximum RSRQ of the terminal device minus a minimum RSRQ of the terminal device within a sliding time window T1 is greater than a RSRQ threshold RSRQ_th_up, the scheduling information type is determined to be within-slot scheduling, not cross-slot scheduling; when the value of the maximum RSRQ of the terminal device minus the minimum RSRQ of the terminal device within the sliding time window T1 is less than or equal to RSRQ_th_down, the scheduling information type is determined to be cross-slot scheduling.

For example, taking the indicator reflecting the signal situation within the sliding time window being BLER as an example, when the base station determines that a value of a maximum BLER of the terminal device minus a minimum BLER of the terminal device within a sliding time window T1 is greater than a BLER threshold BLER_th_up, the scheduling information type is determined to be within-slot scheduling, not cross-slot scheduling; when the value of the maximum BLER of the terminal device minus the minimum BLER of the terminal device within the sliding time window T1 is less than or equal to BLER_th_down, the scheduling information type is determined to be cross-slot scheduling.

It should be noted that the network device may use one of the indicators reflecting the signal situation for judgment, or it may use multiple indicators reflecting the signal situation at the same time for weighted judgment, which is not limited herein.

In some embodiments, the network device determines the scheduling information type according to the movement state of the terminal device, which may include: in a case where the movement state of the terminal device is the first movement state, the scheduling information type is determined to be within-slot scheduling; in a case where the movement state of the terminal device is the second movement state, the scheduling information type is determined to be cross-slot scheduling.

In some embodiments, in a case where the movement state of the terminal device is the third movement state, the network device determines that the scheduling information type is an existing scheduling information type; when the existing scheduling information type is within-slot scheduling, the scheduling information type is determined to be within-slot scheduling, and when the existing scheduling information type is cross-slot scheduling, the scheduling information type is determined to be cross-slot scheduling. That is, the scheduling information type is not changed. In some embodiments, the network device may send instruction information to the terminal device, instructing not to change the scheduling information type, and the terminal device schedules resources according to the existing scheduling information; alternatively, the network device may not send instruction information to the terminal device, and the terminal device schedules resources according to the existing scheduling information.

Operation 203: the network device sends first scheduling information or second scheduling information to the terminal device, where the first scheduling information is configured for the terminal device to perform cross-slot scheduling of resources, and the second scheduling information is configured for the terminal device to perform within-slot scheduling of resources.

The terminal device receives the first scheduling information sent by the network device or receives the second scheduling information sent by the network device.

In some embodiments, within continuous sliding time windows, where a number of the continuous sliding time windows satisfies a first quantity threshold, in a case where it is determined according to the indicators reflecting the signal situation that the scheduling information type in each sliding time window is all cross-slot scheduling, the first scheduling information is sent to the terminal device, and the first scheduling information is configured for the terminal device to perform cross-slot scheduling of resources; and/or
within continuous sliding time windows, where a number of the continuous sliding time windows satisfies a second quantity threshold, in a case where it is determined according to the indicators reflecting the signal situation that the scheduling information type in each sliding time window is all within-slot scheduling, the second scheduling information is sent to the terminal device, and the second scheduling information is configured for the terminal device to perform within-slot scheduling of resources.

In some embodiments, the first quantity threshold and the second quantity threshold may be the same or different. In some embodiments, the first quantity threshold or the second quantity threshold may be two or more.

It can be understood that within the sliding time windows where the quantity threshold is satisfied, it is determined whether there is at least one the indicator in each sliding time window of which the change amount continuously exceeds a corresponding preset value. When the corresponding preset value is continuously exceeded, it may be evaluated that the terminal device is in a state of high-speed movement or a state of drastic signal changes, and the scheduling information is determined to be the second scheduling information, which is configured for the terminal device to perform within-slot scheduling of resources, and not cross-slot scheduling of resources. When the corresponding preset value is not continuously exceeded, it may be evaluated that the terminal device is in a state of low-speed movement or a state of stable signal changes, and the scheduling information is determined to be the first scheduling information, which is configured for the terminal device to perform cross-slot scheduling of resources.

For example, when the change in the maximum RSRP and the minimum RSRP exceeds a corresponding preset RSRP value in eight consecutive sliding time windows out of ten sliding time windows, the scheduling information is evaluated as the second scheduling information, which is configured for the terminal device to perform within-slot scheduling of resources. When the change in the maximum RSRP and the minimum RSRP exceeds the corresponding preset RSRP value in only one sliding time window out of ten sliding time windows, the scheduling information is evaluated as the first scheduling information, which is configured for the terminal device to perform cross-slot scheduling of resources.

In some embodiments, within continuous sliding time windows, where the number of the continuous sliding time windows the a first quantity threshold, in a case where it is determined according to the indicators reflecting the signal situation that the scheduling information type in each sliding time window is all cross-slot scheduling, the first scheduling information is sent to the terminal device, which may include: within the continuous sliding time windows, in a case where it is determined according to the indicators reflecting the signal situation that the scheduling information type in each sliding time window is all cross-slot scheduling, it is determined whether there are other restrictions limiting the cross-slot scheduling; when there are no other restrictions limiting the cross-slot scheduling, the first scheduling information is sent to the terminal device.

In some embodiments, the method may further include: when there are other restrictions limiting the cross-slot scheduling, sending the second scheduling information to the terminal device.

In some embodiments, the other restrictions limiting cross-slot scheduling include: when the terminal device is performing high reliability and low latency services, restricting the cross-slot scheduling.

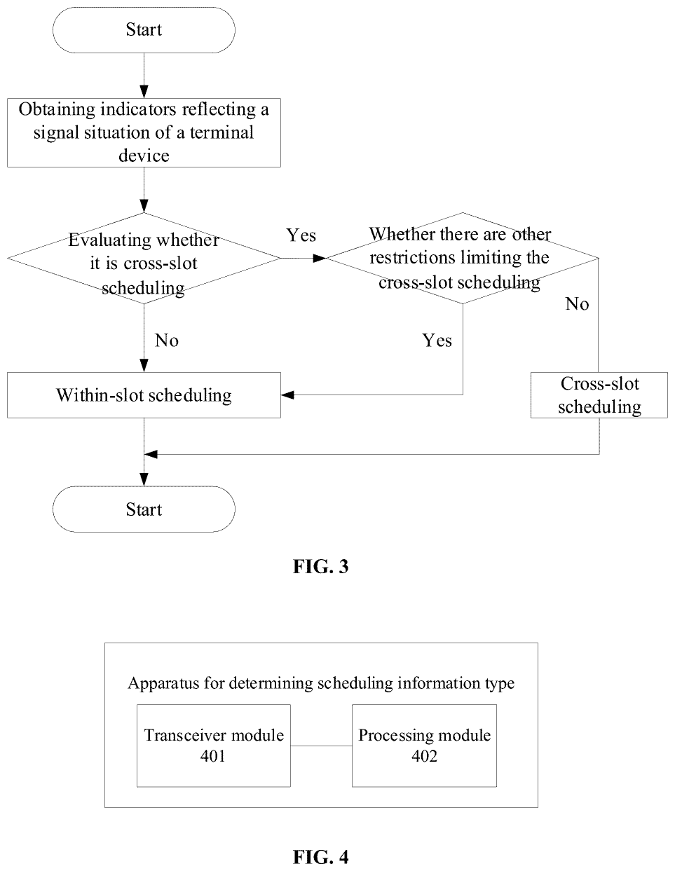

It can be understood that for a terminal device for which it is determined that the scheduling information type is all cross-slot scheduling, it is further necessary to evaluate whether there are other restrictions that limit the cross-slot scheduling. For example, for the terminal device for which it is determined that the scheduling information type is all cross-slot scheduling, when the terminal device is performing Ultra-reliable and Low Latency Communications (uRLLC) services, cross-slot scheduling is still restricted. As shown in FIG. 3, FIG. 3 is a flowchart of a method for determining scheduling information type according to other embodiments of the present disclosure.

It should be explained that the service performed by the terminal device may be reported to the network device via the Quality of Service class identifier (Qos class identifier, QCI) or 5QI. A brief description of QCI and 5QI is provided below:

QCI is a parameter used by the LTE system to identify the transmission characteristics of service data packets. The protocol defines QCI values corresponding to different bearer services. The range of QCI is 1-9, corresponding to different resource types, different priorities, different delays, and different packet loss rates. To ensure the normal operation of a certain application service, the service needs to be configured with a matching QCI value. Wireless bearers are divided into signaling radio bearers (SRB) and data radio bearers (DRB), where SRB is used for signaling transmission and DRB is used for data transmission. The scheduling priority of all SRBs is higher than that of all DRBs. Bearers may be divided into two categories based on QCI: guaranteed bit rate (GBR) bearer and non-guaranteed bit rate (non-GBR) bearer.

GRB bearer is used for services with high real-time requirements, and a scheduler is required to guarantee a minimum bit rate for this type of bearer. The QCI range is 1-4.

Non-GRB bearer is used for services with low real-time requirements, and the scheduler is not required to guarantee a minimum bit rate for this type of bearer. The QCI range is 5-9.

The definition of 5QI (5QoS Identifier) is defined in 3rd Generation Partnership Project (3GPP) specification 23.501. 5QI is a scalar that points to 5G QoS (Quality of Service) characteristics (referring to the table below for the QoS settings of the corresponding characteristics). These parameters are configured to control the QoS forwarded and processed by QoS flows.

The User Equipment (UE) in the Non-access Stratum (NAS) layer and the 5GC filter in the 5G wireless network map uplink (UL) and downlink (DL) packets to QoS flows, respectively; while AS layer terminal (UE) and access network (AN) map QoS flows to data radio bearer (DRB) according to the Service Data Adaptation Protocol (SDAP).

Same as QCI in LTE network, 5QI is an indication in the 5G network of a set of QoS data flows between the terminal (UE) and the core network (UPF, User Plane Function), including priority, packet delay, or packet error rate, etc.; these QoS characteristics may be GBR or Non-GBR.

The QoS flows in 5G (New Radio, NR) network include:
5G QoS identifier (5QI);

Assignment and reservation of priority (ARP, Address Resolution Protocol).

The GBR QoS flows include:
DL and UL guaranteed flow bit rate;
DL and UL maximum flow bit rate;
DL and UL maximum packet loss rate.

The QoS model defined in 3GPP TS 23.501 is based on QoS Flows, which support both GBR (guaranteed bit rate, guaranteed throughput) and Non-GBR (no guaranteed bit rate, no guaranteed throughput); in 5G (NR) networks, Delay Critical GBR (high reliability and low latency) services have been added. Different QoS flow types (such as GBR, Non-GBR, and Delay Critical GBR) correspond to different standard 5QI values. Among these, 5QI values from 128 to 254 are non-standardized and may be used for specific configurations by the operator.

Understandably, in some embodiments, the relevant definitions may refer to the descriptions in the relevant standards, and may change with changes in the relevant standards.

It is understood that on the base station side, the terminal device may be evaluated as being in a state of high-speed movement or a state of drastic signal change based on the indicators reflecting the signal situation of the terminal device within multiple sliding time windows; when it is evaluated that the terminal device is in a state of high-speed movement or a state of drastic signal change or with real-time service requirements, within-slot scheduling may be adopted; when it is evaluated that the terminal device is in a state of low-speed movement or a state of stable signal change or not with real-time service requirements, cross-slot scheduling may be adopted. Because drastic changes in the signal may occur when the terminal device moves at high speed, the evaluation of the indicators reflecting the signal situation of the terminal device within multiple sliding time windows may take this scenario into account.

In some embodiments, when the movement state of the terminal device is the first movement state, the network device determines that the scheduling information type is within-slot scheduling; the network device sends the second scheduling information to the terminal device, and the second scheduling information is configured for the terminal device to perform within-slot scheduling of resources; or,
when the movement state of the terminal device is the second movement state, the network device determines that the scheduling information type is cross-slot scheduling; the network device sends the first scheduling information to the terminal device, and the first scheduling information is configured for the terminal device to perform cross-slot scheduling of resources.

In some embodiments, after the network device determines that the scheduling information type is cross-slot scheduling when the movement state of the terminal device is the second movement state, the method may further include: determining whether there are other restrictions limiting the cross-slot scheduling; when there are no other restrictions limiting the cross-slot scheduling, sending the first scheduling information to the terminal device; when there are other restrictions limiting the cross-slot scheduling, sending the second scheduling information to the terminal device.

In some embodiments, the other restrictions that restrict cross-slot scheduling include: when the terminal device is performing high reliability and low latency services, restricting the cross-slot scheduling.

It can be understood that on the base station side, the movement state of the terminal device may be evaluated according to the movement state of the terminal device; when it is evaluated that the terminal device is in a state of high-speed movement or with real-time service requirements, the within-slot scheduling may be adopted; when it is evaluated that the terminal device is in a state of low-speed movement and not with real-time service requirements, the cross-slot scheduling may be adopted.

In some embodiments, within continuous sliding time windows, where a number of the continuous sliding time windows satisfies a first quantity threshold, in a case where it is determined according to the indicators reflecting the signal situation that the scheduling information type in each sliding time window is all cross-slot scheduling, and the network device determines according to the movement state of the terminal device that the scheduling information type is the cross-slot scheduling, the first scheduling information is sent to the terminal device, and the first scheduling information is configured for the terminal device to perform cross-slot scheduling of resources; or
within continuous sliding time windows, where a number of the continuous sliding time windows satisfies a second quantity threshold, in a case where it is determined according to the indicators reflecting the signal situation that the scheduling information type in each sliding time window is all within-slot scheduling, and the network device determines according to the movement state of the terminal device that the scheduling information type is the within-slot scheduling, the second scheduling information is sent to the terminal device, and the second scheduling information is configured for the terminal device to perform within-slot scheduling of resources; or
within continuous sliding time windows, where a number of the continuous sliding time windows satisfies a first quantity threshold, in a case where it is determined according to the indicators reflecting the signal situation that the scheduling information type in each sliding time window is all cross-slot scheduling, and the network device determines according to the movement state of the terminal device that the scheduling information type is the within-slot scheduling, the network device determines that the scheduling information type is an existing scheduling information type; when the existing scheduling information type is within-slot scheduling, the scheduling information type is determined to be within-slot scheduling, and when the existing scheduling information type is cross-slot scheduling, the scheduling information type is determined to be cross-slot scheduling. That is, the scheduling information type is not changed. The network device may send instruction information to the terminal device, instructing not to change the scheduling information type, and the terminal device schedules resources according to the existing scheduling information; alternatively, the network device may not send instruction information to the terminal device, and the terminal device schedules resources according to the existing scheduling information; or
within continuous sliding time windows, where a number of the continuous sliding time windows satisfies a second quantity threshold, in a case where it is determined according to the indicators reflecting the signal situation that the scheduling information type in each sliding time window is all within-slot scheduling, and the network device determines according to the movement state of the terminal device that the scheduling information type is the cross-slot scheduling, the network device determines that the scheduling information type is an existing scheduling information type; when the existing scheduling information type is within-slot scheduling, the scheduling information type is determined to be within-slot scheduling, and when the existing scheduling information type is cross-slot scheduling, the scheduling information type is determined to be cross-slot scheduling. That is, the scheduling information type is not changed. The network device may send instruction information to the terminal device, instructing not to change the scheduling information type, and the terminal device schedules resources according to the existing scheduling information; alternatively, the network device may not send instruction information to the terminal device, and the terminal device schedules resources according to the existing scheduling information.

Operation 204: the terminal device performs cross-slot scheduling of resources according to the first scheduling information or performs within-slot scheduling of resources according to the second scheduling information.

It can be understood that the technical solutions of the present disclosure provide a method for data scheduling, which determines the feasibility of scheduling across time slots for the terminal device by evaluating at least one of the signal situation and the movement state of the terminal device. The network device determines the scheduling information according to the determination result; issues the scheduling information to the terminal device; and the terminal device schedules resources according to the scheduling information. In this way, under the current technical framework, the scheduling in scenarios with drastic signal changes may be more accurate, such that the scheduling result more closely matches the signal situations of the terminal device when it is in services, and the overall throughput rate is improved.

It should be noted that steps 203-204 are optional.

In the embodiments of the present disclosure, the network device obtains at least one of: indicators reflecting a signal situation of the terminal device within a sliding time window, and a movement state of the terminal device; and determines the scheduling information type according to the at least one of the indicators reflecting the signal situation within the sliding time window and the movement state of the terminal device, where the scheduling information type is either cross-slot scheduling or within-slot scheduling. The feasibility of scheduling the terminal device across time slots may be determined by evaluating at least one of the signal situation and the movement state of the terminal device, such that the scheduling result more closely matches the signal situation when the terminal device is in services, and the overall throughput rate is improved.

As shown in FIG. 4, FIG. 4 is a schematic diagram of an apparatus for determining scheduling information type according to some embodiments of the present disclosure. The apparatus may include:
a transceiver module 401, configured to obtain at least one of: indicators reflecting a signal situation of a terminal device within a sliding time window, and a movement state of the terminal device;
a processing module 402, configured to determine a scheduling information type according to the at least one of the indicators reflecting the signal situation within the sliding time window and the movement state of the terminal device, where the scheduling information type is either cross-slot scheduling or within-slot scheduling.

In some embodiments, the transceiver module 401 is further configured to send first scheduling information to the terminal device, in a case where it is determined according to the indicators reflecting the signal situation that the scheduling information type in each sliding time window is all cross-slot scheduling, within continuous sliding time windows, where a number of the continuous sliding time windows satisfies a first quantity threshold; where the first scheduling information is configured for the terminal device to perform cross-slot scheduling of resources; and/or
the transceiver module 401 is further configured to send second scheduling information to the terminal device, in a case where it is determined according to the indicators reflecting the signal situation that the scheduling information type in each sliding time window is all within-slot scheduling, within continuous sliding time windows, where a number of the continuous sliding time windows satisfies a second quantity threshold; where the second scheduling information is configured for the terminal device to perform within-slot scheduling of resources.

In some embodiments, the transceiver module 401 is specifically configured to determine whether there are other restrictions limiting cross-slot scheduling, in a case where it is determined according to the indicators reflecting the signal situation that the scheduling information type in each sliding time window is all cross-slot scheduling, within the continuous sliding time windows, where the number of the continuous sliding time windows satisfies the first quantity threshold; and when there are no other restrictions limiting the cross-slot scheduling, send the first scheduling information to the terminal device.

In some embodiments, the transceiver module 401 is further configured to send the second scheduling information to the terminal device when there are other restrictions limiting the cross-slot scheduling.

In some embodiments, the other restrictions limiting cross-slot scheduling include: restricting the cross-slot scheduling when the terminal device is performing high reliability and low latency services.

In some embodiments, the indicator reflecting the signal situation includes at least one of: Reference Signal Receiving Power (RSRP), Received Signal Strength Indicator (RSSI), Reference Signal Receiving Quality (RSRQ), and Block Error Rate (BLER).

In some embodiments, the processing module 402 is specifically configured to determine the scheduling information type to be within-slot scheduling, in a case where a change in a maximum value and a minimum value of each of at least one indicator included in the indicators reflecting the signal situation within the sliding time window is greater than a corresponding first preset value; and/or
the processing module 402 is specifically configured to determine the scheduling information type to be cross-slot scheduling, in a case where a change in a maximum value and a minimum value of each indicator included in the indicators reflecting the signal situation within the sliding time window is less than or equal to a corresponding second preset value; where the corresponding first preset value is greater than or equal to the corresponding second preset value.

In some embodiments, the movement state of the terminal device includes a first movement state or a second movement state, and a movement speed of the first movement state is greater than a movement speed of the second movement state.

In some embodiments, the processing module 402 is specifically configured to determine the scheduling information type to be within-slot scheduling when the movement state of the terminal device is the first movement state; and
the transceiver module 401 is further configured to send second scheduling information to the terminal device, and the second scheduling information is configured for the terminal device to perform within-slot scheduling of resources.

In some embodiments, the processing module 402 is specifically configured to determine the scheduling information type to be cross-slot scheduling when the movement state of the terminal device is the second movement state; and
the transceiver module 401 is further configured to send first scheduling information to the terminal device, and the first scheduling information is configured for the terminal device to perform cross-slot scheduling of resources.

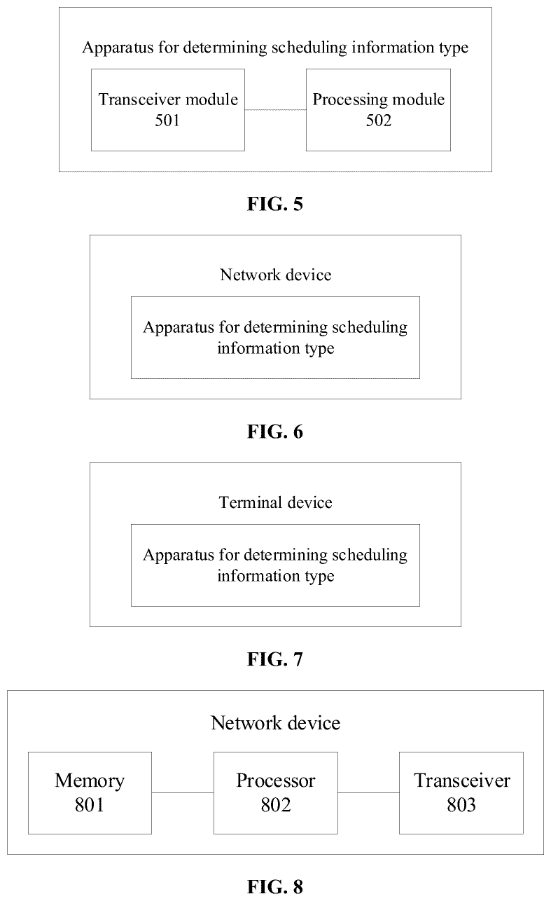

As shown in FIG. 5, FIG. 5 is a schematic diagram of an apparatus for determining scheduling information type according to other embodiments of the present disclosure. The apparatus may include: a transceiver module 501 and a processing module 502.

The transceiver module 501 is configured to report to a network device at least one of: indicators reflecting a signal situation of a terminal device within a sliding time window, and a movement state of the terminal device; where the at least one of the indicators reflecting the signal situation within the sliding time window and the movement state of the terminal device is configured to determine a scheduling information type, and the scheduling information type is either cross-slot scheduling or within-slot scheduling.

In some embodiments, the transceiver module 501 is further configured to receive first scheduling information sent by the network device; and
the processing module 502 is configured to perform cross-slot scheduling of resources according to the first scheduling information; or,
the transceiver module 501 is configured to receive second scheduling information sent by the network device; and
the processing module 502 is configured to perform within-slot scheduling of resources according to the second scheduling information.

As shown in FIG. 6, FIG. 6 is a schematic diagram of a network device according to some embodiments of the present disclosure. The network device may include the apparatus as shown in FIG. 4.

As shown in FIG. 7, FIG. 7 is a schematic diagram of a terminal device according to some embodiments of the present disclosure. The network device may include the apparatus as shown in FIG. 5.

As shown in FIG. 8, FIG. 8 is a schematic diagram of a network device according to other embodiments of the present disclosure. The network device may include:
a memory 801, storing executable program code;
a processor 802 and a transceiver 803, that are coupled to the memory 801.

The transceiver 803 is configured to obtain at least one of: indicators reflecting a signal situation of a terminal device within a sliding time window, and a movement state of the terminal device;

The processor 802 is configured to determine a scheduling information type according to the at least one of the indicators reflecting the signal situation within the sliding time window and the movement state of the terminal device, where the scheduling information type is either cross-slot scheduling or within-slot scheduling.

In some embodiments, the transceiver 803 is further configured to send first scheduling information to the terminal device, in a case where it is determined according to the indicators reflecting the signal situation that the scheduling information type in each sliding time window is all cross-slot scheduling, within continuous sliding time windows, where a number of the continuous sliding time windows satisfies a first quantity threshold; where the first scheduling information is configured for the terminal device to perform cross-slot scheduling of resources; and/or
the transceiver 803 is further configured to send second scheduling information to the terminal device, in a case where it is determined according to the indicators reflecting the signal situation that the scheduling information type in each sliding time window is all within-slot scheduling, within continuous sliding time windows, where a number of the continuous sliding time windows satisfies a second quantity threshold; where the second scheduling information is configured for the terminal device to perform within-slot scheduling of resources.

In some embodiments, the transceiver 803 is specifically configured to determine whether there are other restrictions limiting cross-slot scheduling, in a case where it is determined according to the indicators reflecting the signal situation that the scheduling information type in each sliding time window is all cross-slot scheduling, within the continuous sliding time windows, where the number of the continuous sliding time windows satisfies the first quantity threshold; and when there are no other restrictions limiting the cross-slot scheduling, send the first scheduling information to the terminal device.

In some embodiments, the transceiver 803 is further configured to send the second scheduling information to the terminal device when there are other restrictions limiting the cross-slot scheduling.

In some embodiments, the other restrictions limiting cross-slot scheduling include: restricting the cross-slot scheduling when the terminal device is performing high reliability and low latency services.

In some embodiments, the indicator reflecting the signal situation includes at least one of: Reference Signal Receiving Power (RSRP), Received Signal Strength Indicator (RSSI), Reference Signal Receiving Quality (RSRQ), and Block Error Rate (BLER).

In some embodiments, the processor 802 is specifically configured to determine the scheduling information type to be within-slot scheduling, in a case where a change in a maximum value and a minimum value of each of at least one indicator included in the indicators reflecting the signal situation within the sliding time window is greater than a corresponding first preset value; and/or
the processor 802 is specifically configured to determine the scheduling information type to be cross-slot scheduling, in a case where a change in a maximum value and a minimum value of each indicator included in the indicators reflecting the signal situation within the sliding time window is less than or equal to a corresponding second preset value; where the corresponding first preset value is greater than or equal to the corresponding second preset value.

In some embodiments, the movement state of the terminal device includes a first movement state or a second movement state, and a movement speed of the first movement state is greater than a movement speed of the second movement state.

In some embodiments, the processor 802 specifically configured to determine the scheduling information type to be within-slot scheduling when the movement state of the terminal device is the first movement state; and
the transceiver 803 is further configured to send second scheduling information to the terminal device, and the second scheduling information is configured for the terminal device to perform within-slot scheduling of resources.

In some embodiments, the processor 802 is specifically configured to determine the scheduling information type to be cross-slot scheduling when the movement state of the terminal device is the second movement state; and
the transceiver 803 is further configured to send first scheduling information to the terminal device, and the first scheduling information is configured for the terminal device to perform cross-slot scheduling of resources.

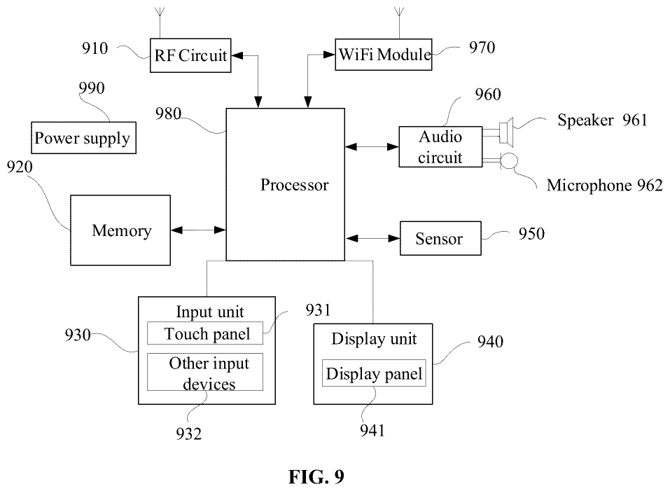

As shown in FIG. 9, FIG. 9 is a schematic diagram of a terminal device according to other embodiments of the present disclosure.

FIG. 9 shows a block diagram of a partial structure of a mobile phone associated with the terminal device provided in the embodiments of the present disclosure. Referring to FIG. 9, the mobile phone includes: a radio frequency (RF) circuit 910, a memory 920, an input unit 930, a display unit 940, a sensor 950, an audio circuit 960, a wireless fidelity (Wi-Fi) module 970, a processor 980, and a power supply 990. Those skilled in the art will understand that the structure of the mobile phone shown in FIG. 9 does not constitute a limitation on the mobile phone, and may include more or fewer components than those shown, or a combination of some components, or a different arrangement of components.

The following is a specific description of each component of the mobile phone in conjunction with FIG. 9.

The RF circuit 910 may be configured to receive and transmit signals during message or phone calls. In particular, it receives downlink messages from the base station and transmits them to the processor 980 for processing; in addition, it sends uplink data to the base station. Generally, the RF circuit 910 includes, but is not limited to, an antenna, at least one amplifier, a transceiver, a coupler, a low noise amplifier (LNA), a duplexer, etc. In addition, the RF circuit 910 may communicate with a network and other devices via wireless communication. The wireless communication may use any communication standard or protocol, including but not limited to Global System for Mobile communication (GSM), General Packet Radio Service (GPRS), Code Division Multiple Access (CDMA), Wideband Code Division Multiple Access (WCDMA), Long Term Evolution (LTE), e-mail, Short Messaging Service (SMS), etc.

The memory 920 may be configured to store software programs and modules, and the processor 980 executes various functional applications and data processing of the mobile phone by running the software programs and modules stored in the memory 920. The memory 920 may mainly include a storage program area and a storage data area, where the storage program area may store an operating system, at least one application required for a function (e.g., a sound playback function, an image playback function, etc.), etc.; the storage data area may store data created based on use of the mobile phone (e.g., audio data, a phonebook, etc.), etc. In addition, memory 920 may include high-speed random-access memory and may further include non-volatile memory, such as at least one disk storage device, flash memory device, or other volatile solid-state storage device.

The input unit 930 may be configured to receive input of digital or character information and to generate key signal input related to user settings and function control of the mobile phone. Specifically, the input unit 930 may include a touch panel 931 and other input devices 932. The touch panel 931, also referred to as a touch screen, may collect touch operations performed by a user on or near the touch panel 931 (e.g., operations performed by the user using any suitable object or accessory such as a finger or stylus) and drive corresponding connected devices according to a pre-set program. In some embodiments, the touch panel 931 may include a touch detection device and a touch controller. The touch detection device detects the user's touch position and detects the signal caused by the touch operation, and transmits the signal to the touch controller. The touch controller receives the touch information from the touch detection device, converts it into contact coordinates, and then sends it to the processor 980. The touch controller may further receive commands from the processor 980 and execute them. In addition, the touch panel 931 may be implemented using various types such as resistive, capacitive, infrared, and surface acoustic wave. In addition to the touch panel 931, the input unit 930 may further include other input devices 932. Specifically, the other input devices 932 may include one or more of the following: a physical keyboard, function keys (such as volume control keys, switch keys, etc.), trackballs, mice, joysticks, etc.

The display unit 940 may be configured to display information input by or provided to the user and various menus of the mobile phone. The display unit 940 may include a display panel 941, which may be configured in the form of an optional liquid crystal display (LCD) or an organic light-emitting diode (OLED). Further, the touch panel 931 may cover the display panel 941, and when the touch panel 931 detects a touch operation on or near it, transmits to the processor 980 to determine the type of touch event, and the processor 980 then provides a corresponding visual output on the display panel 941 based on the type of touch event. Although in FIG. 9, the touch panel 931 and the display panel 941 are implemented as two separate components to implement the input and output functions of the mobile phone, in some embodiments, the touch panel 931 and the display panel 941 may be integrated to implement the input and output functions of the mobile phone.

The mobile phone may further include at least one sensor 950, such as a light sensor, a motion sensor and other sensors. Specifically, the light sensor may include an ambient light sensor and a proximity sensor, where the ambient light sensor may adjust the brightness of the display panel 941 according to the brightness of the ambient light, and the proximity sensor may turn off the display panel 941 and/or the backlight when the mobile phone is moved to the ear. As a type of motion sensor, the accelerometer sensor may detect the magnitude of acceleration in various directions (typically three axes), and when stationary, it may detect the magnitude and direction of gravity. The accelerometer sensor may be used in applications that recognize the phone's attitude (such as landscape/portrait screen switching, related games, and magnetometer attitude calibration), vibration recognition-related functions (such as pedometers, tapping), etc. As for other sensors that can further be configured on the phone, such as gyroscopes, barometers, hygrometers, thermometers, infrared sensors, etc., they will not be discussed herein.

The audio circuit 960, the speaker 961, and the microphone 962 provide an audio interface between the user and the mobile phone. The audio circuit 960 converts the received audio data into an electrical signal and transmits it to the speaker 961, which converts it into an audible signal. On the other hand, the microphone 962 converts the collected audible signal into an electrical signal, which is received by the audio circuit 960 and converted into audio data. The audio data is then output to the processor 980 for processing, and then sent to another mobile phone via the RF circuit 910, or output to the memory 920 for further processing.

Wi-Fi is a short-range wireless transmission technology. The mobile phone may help the user send and receive e-mails, browse the web and access streaming media, etc., via the Wi-Fi module 970, which provides the user with wireless broadband Internet access. Although FIG. 9 shows the Wi-Fi module 970, it is understood that it is not a necessary component of the mobile phone and may be omitted when necessary, without changing the essence of the present disclosure.

The processor 980 is the control center of the mobile phone, connecting various parts of the entire mobile phone using various interfaces and lines, and monitoring the mobile phone as a whole by running or executing software programs stored in the memory 920 and/or modules, and calling up data stored in the memory 920 to perform various functions of the mobile phone and process data. In some embodiments, the processor 980 may include one or more processing units. In some embodiments, the processor 980 may integrate an application processor and a modem processor, where the application processor mainly processes an operating system, a user interface, and applications, etc., and the modem processor mainly processes wireless communication. It is understood that the modem processor may not be integrated into processor 980.

The mobile phone may further include a power supply 990 that supplies power to the various components (e.g., a battery). In some embodiments, the power supply may be logically connected to the processor 980 via a power management system, such that functions such as charging, discharging, and power consumption management may be performed via the power management system.

Although not shown, the mobile phone may further include a camera, a Bluetooth module, etc., which will not be described in detail herein.

In the embodiments of the present disclosure, the RF circuit 910 is configured to report to a network device at least one of: indicators reflecting a signal situation of a terminal device within a sliding time window, and a movement state of the terminal device; where the at least one of the indicators reflecting the signal situation within the sliding time window and the movement state of the terminal device is configured to determine a scheduling information type, and the scheduling information type is either cross-slot scheduling or within-slot scheduling.

In some embodiments, the RF circuit 910 is further configured to receive first scheduling information sent by the network device; and
the processor 980 is configured to perform cross-slot scheduling of resources according to the first scheduling information; or,
the RF circuit 910 is configured to receive second scheduling information sent by the network device; and
the processor 980 is configured to performs within-slot scheduling of resources according to the second scheduling information.

In the aforementioned embodiments, all or part of the same may be implemented by software, hardware, firmware, or any combination thereof. When implemented using software, all or part of the same may be implemented in the form of a computer program product. The computer program product includes one or more computer program instructions. When loaded and executed on a computer, all or part of the computer program instructions produce the process or function described in accordance with the embodiments of the present disclosure. The computer may be a general-purpose computer, a dedicated computer, a computer network, or other programmable device. The computer instructions may be stored in a computer-readable storage medium or transferred from one computer-readable storage medium to another computer-readable storage medium, for example, the computer instructions may be transferred from one website, computer, server or data center to another website, computer, server or data center by wire (e.g., coaxial cable, fiber optics, digital subscriber line (DSL)) or wirelessly (e.g., infrared, wireless, microwave, etc.). The computer-readable storage medium may be any available medium that can be stored by a computer or a data storage device, such as a server or data center, that includes one or more integrated available media. The available media may be magnetic media (e.g., floppy disks, hard disks, magnetic tapes), optical media (e.g., DVDs), or semiconductor media (e.g., solid state disks (SSDs)), etc.

As those skilled in the art will be aware, for the sake of convenience and conciseness of description, the specific working processes of the systems, apparatuses, and units described above may refer to the corresponding processes in the preceding method embodiments, which will not be described in detail herein.

In the several embodiments provided in the present disclosure, it should be understood that the systems, apparatuses, and methods disclosed may be implemented in other ways. For example, the embodiments of the apparatuses described above are merely illustrative. For example, the division of the units described is merely a logical functional division, and the actual implementation may have a different division, for example, multiple units or components may be combined or integrated into another system, or some features may be ignored or not implemented. Another point is that the coupling or direct coupling or communication connection shown or discussed with each other may be an indirect coupling or communication connection through some interface, device, or unit, which may be electrical, mechanical, or other.

The units described as separate components may be or may not be physically separate, and the components shown as units may be or may not be physical units, i.e., they may be located in one place or may be distributed over multiple network units. Some or all of these units may be selected as needed to achieve the purpose of this embodiment.

In addition, the functional units in the embodiments of the present disclosure may be integrated into a processing unit, or they may be physically present separately, or two or more units may be integrated into one unit. The above-mentioned integrated units may be implemented in the form of either hardware or software functional units.

The integrated units, when implemented in the form of software functional units and sold or used as independent products, may be stored in a computer-readable storage medium. On this understanding, the technical solution of the present disclosure, in essence or in the part that contributes to the prior art, or the whole or part of the technical solution, may be embodied in the form of a software product, the computer software product being stored in a storage medium and including instructions for causing a computer device (which may be a personal computer, a server, or network device, etc.) to perform all or part of the steps of the methods described in various embodiments of the present disclosure. The aforementioned storage media include: USB flash drives, portable hard drives, read-only memory (ROM), random access memory (RAM), magnetic disks or optical disks, and various other media that can store program code.

It should be noted that the terms of “plural” and any variants thereof in the present disclosure refers to two or more unless otherwise specified.

The above is only intended to illustrate, not to limit, the technical solution of the present disclosure. Despite the detailed description of the present disclosure with reference to the preceding embodiments, those skilled in the art should understand that the technical solutions recorded in the preceding embodiments may still be modified, or some of the technical features may be replaced by equivalents; and these modifications or replacements do not cause the essence of the corresponding technical solutions to depart from the spirit and scope of the technical solutions in the embodiments of the present disclosure.

What is claimed is:

1. A method for determining a scheduling information type, performed by a network device and comprising:
obtaining at least one of indicators reflecting a signal situation of a terminal device within a sliding time window, and a movement state of the terminal device; and
determining the scheduling information type according to the at least one of the indicators reflecting the signal situation within the sliding time window and the movement state of the terminal device; wherein the scheduling information type is either cross-slot scheduling or within-slot scheduling.

2. The method according to claim 1, further comprising:
sending first scheduling information to the terminal device, in a case where within continuous sliding time windows and a number of the continuous sliding time windows reaches a first quantity threshold, it is determined according to the indicators reflecting the signal situation that the scheduling information type within each of the continuous sliding time windows is all cross-slot scheduling; wherein the first scheduling information is configured for the terminal device to perform cross-slot scheduling of resources; and/or
sending second scheduling information to the terminal device, in a case where within continuous sliding time windows and a number of the continuous sliding time windows reaches a second quantity threshold, it is determined according to the indicators reflecting the signal situation that the scheduling information type in each of the continuous sliding time windows is all within-slot scheduling; wherein the second scheduling information is configured for the terminal device to perform within-slot scheduling of resources.

3. The method according to claim 2, wherein the sending first scheduling information to the terminal device, in a case where within continuous sliding time windows and a number of the continuous sliding time windows reaches a first quantity threshold, it is determined according to the indicators reflecting the signal situation that the scheduling information type within each of the continuous sliding time windows is all cross-slot scheduling, comprises:
determining whether there are other restrictions limiting the cross-slot scheduling, in a case where within the continuous sliding time windows and the number of the continuous sliding time windows satisfies the first quantity threshold, it is determined according to the indicators reflecting the signal situation that the scheduling information type in each of the continuous sliding time windows is all cross-slot scheduling; and
sending the first scheduling information to the terminal device, in a case where there are no other restrictions limiting the cross-slot scheduling.

4. The method according to claim 3, further comprising:
sending the second scheduling information to the terminal device, in a case where there are other restrictions limiting the cross-slot scheduling.

5. The method according to claim 3, where the other restrictions limiting the cross-slot scheduling comprise:
restricting the cross-slot scheduling, in a case where the terminal device is performing high reliability and low latency services.

6. The method according to claim 1, wherein each indicator reflecting the signal situation comprises at least one of Reference Signal Receiving Power (RSRP), Received Signal Strength Indicator (RSSI), Reference Signal Receiving Quality (RSRQ), and Block Error Rate (BLER).

7. The method according to claim 1, wherein the determining the scheduling information type according to the indicators reflecting the signal situation within the sliding time window comprises:
determining the scheduling information type to be within-slot scheduling, in a case where a change in a maximum value and a minimum value of each of at least one indicator included in the indicators reflecting the signal situation within the sliding time window is greater than a corresponding first preset value; and/or
determining the scheduling information type to be cross-slot scheduling, in a case where a change in a maximum value and a minimum value of each indicator included in the indicators reflecting the signal situation within the sliding time window is less than or equal to a corresponding second preset value;
wherein the corresponding first preset value is greater than or equal to the corresponding second preset value.

8. The method according to claim 7, wherein the determining the scheduling information type according to the indicators reflecting the signal situation within the sliding time window further comprises:
determining the scheduling information type to be an existing scheduling information type, in a case where the change in the maximum value and the minimum value of each indicator included in the indicators reflecting the signal situation within the sliding time window is greater than the corresponding second preset value and less than or equal to the corresponding first preset value; wherein the existing scheduling information type is either cross-slot scheduling or within-slot scheduling.

9. The method according to claim 1, where the movement state of the terminal device comprises a first movement state or a second movement state, and a movement speed of the first movement state is greater than a movement speed of the second movement state.

10. The method according to claim 9, wherein the determining the scheduling information type according to the movement state of the terminal device comprises:
determining the scheduling information type to be within-slot scheduling, in a case where the movement state of the terminal device is the first movement state;
wherein the method further comprises:
sending second scheduling information to the terminal device, wherein the second scheduling information is configured for the terminal device to perform within-slot scheduling of resources.

11. The method according to claim 9, wherein the determining the scheduling information type according to the movement state of the terminal device comprises:
determining the scheduling information type to be cross-slot scheduling, in a case where the movement state of the terminal device is the second movement state;
wherein the method further comprises:
sending first scheduling information to the terminal device, wherein the first scheduling information is configured for the terminal device to perform cross-slot scheduling of resources.

12. The method according to claim 9, wherein the movement state of the terminal device further comprises a third movement state, and the movement speed of the first movement state is greater than a movement speed of the third movement state, and the movement speed of the third movement state is greater than the movement speed of the second movement state;
wherein the determining the scheduling information type according to the movement state of the terminal device further comprises:
determining the scheduling information type to be an existing scheduling information type, in a case where the movement state of the terminal device is the third movement state; wherein the existing scheduling information type is either cross-slot scheduling or within-slot scheduling.

13. The method according to claim 1, further comprising:
sending first scheduling information to the terminal device, in a case where within continuous sliding time windows and a number of the continuous sliding time windows reaches a first quantity threshold, it is determined according to the indicators reflecting the signal situation that the scheduling information type in each sliding time window is all cross-slot scheduling, and where it is determined according to the movement state of the terminal device that the scheduling information type is cross-slot scheduling; wherein the first scheduling information is configured for the terminal device to perform cross-slot scheduling of resources; or
sending second scheduling information to the terminal device, in a case where within continuous sliding time windows and a number of the continuous sliding time windows reaches a second quantity threshold, it is determined according to the indicators reflecting the signal situation that the scheduling information type in each sliding time window is all within-slot scheduling, and where it is determined according to the movement state of the terminal device that the scheduling information type is within-slot scheduling; wherein the second scheduling information is configured for the terminal device to perform within-slot scheduling of resources; or
determining that the scheduling information type is an existing scheduling information type, in a case where within continuous sliding time windows, where a number of the continuous sliding time windows reaches a first quantity threshold, it is determined according to the indicators reflecting the signal situation that the scheduling information type in each sliding time window is all cross-slot scheduling, and where it is determined according to the movement state of the terminal device that the scheduling information type is within-slot scheduling; wherein the existing scheduling information type is either cross-slot scheduling or within-slot scheduling; or
determining that the scheduling information type is an existing scheduling information type, in a case where within continuous sliding time windows, where a number of the continuous sliding time windows reaches a second quantity threshold, it is determined according to the indicators reflecting the signal situation that the scheduling information type in each sliding time window is all within-slot scheduling, and where it is determined according to the movement state of the terminal device that the scheduling information type is cross-slot scheduling; wherein the existing scheduling information type is either cross-slot scheduling or within-slot scheduling.

14. A method for determining a scheduling information type, performed by a terminal device and comprising:
reporting to a network device at least one of: indicators reflecting a signal situation of a terminal device within a sliding time window, and a movement state of the terminal device;
wherein the at least one of the indicators reflecting the signal situation within the sliding time window and the movement state of the terminal device is configured to determine the scheduling information type, and the scheduling information type is either cross-slot scheduling or within-slot scheduling.

15. The method according to claim 14, further comprising:
receiving first scheduling information sent by the network device, and performing cross-slot scheduling of resources according to the first scheduling information; or,
receiving second scheduling information sent by the network device, and performing within-slot scheduling of resources according to the second scheduling information.

16. A network device, comprising:
a memory, storing executable program code; and
a processor and a transceiver, that are coupled to the memory;
wherein the network device is configured to perform:
obtaining at least one of indicators reflecting a signal situation of a terminal device within a sliding time window, and a movement state of the terminal device; and
determining the scheduling information type according to the at least one of the indicators reflecting the signal situation within the sliding time window and the movement state of the terminal device; wherein the scheduling information type is either cross-slot scheduling or within-slot scheduling.

17. The network device according to claim 16, further configured to perform:
sending first scheduling information to the terminal device, in a case where within continuous sliding time windows and a number of the continuous sliding time windows reaches a first quantity threshold, it is determined according to the indicators reflecting the signal situation that the scheduling information type within each of the continuous sliding time windows is all cross-slot scheduling; wherein the first scheduling information is configured for the terminal device to perform cross-slot scheduling of resources; and/or
sending second scheduling information to the terminal device, in a case where within continuous sliding time windows and a number of the continuous sliding time windows reaches a second quantity threshold, it is determined according to the indicators reflecting the signal situation that the scheduling information type in each of the continuous sliding time windows is all within-slot scheduling; wherein the second scheduling information is configured for the terminal device to perform within-slot scheduling of resources.

18. The network device according to claim 17, wherein the sending first scheduling information to the terminal device, in a case where within continuous sliding time windows and a number of the continuous sliding time windows reaches a first quantity threshold, it is determined according to the indicators reflecting the signal situation that the scheduling information type within each of the continuous sliding time windows is all cross-slot scheduling, comprises:
determining whether there are other restrictions limiting the cross-slot scheduling, in a case where within the continuous sliding time windows and the number of the continuous sliding time windows satisfies the first quantity threshold, it is determined according to the indicators reflecting the signal situation that the scheduling information type in each of the continuous sliding time windows is all cross-slot scheduling; and
sending the first scheduling information to the terminal device, in a case where there are no other restrictions limiting the cross-slot scheduling.

19. The network device according to claim 16, wherein each indicator reflecting the signal situation comprises at least one of Reference Signal Receiving Power (RSRP), Received Signal Strength Indicator (RSSI), Reference Signal Receiving Quality (RSRQ), and Block Error Rate (BLER).

20. The network device according to claim 16, wherein the determining the scheduling information type according to the indicators reflecting the signal situation within the sliding time window comprises:
determining the scheduling information type to be within-slot scheduling, in a case where a change in a maximum value and a minimum value of each of at least one indicator included in the indicators reflecting the signal situation within the sliding time window is greater than a corresponding first preset value; and/or
determining the scheduling information type to be cross-slot scheduling, in a case where a change in a maximum value and a minimum value of each indicator included in the indicators reflecting the signal situation within the sliding time window is less than or equal to a corresponding second preset value;
wherein the corresponding first preset value is greater than or equal to the corresponding second preset value.
